(19) United States
(12) Patent Application Publication
(10) Pub. No.: US 2007/0206459 A1
(43) Pub. Date: Sep. 6, 2007

(54) Optical disc apparatus

(75) Inventors: Atsushi Iwamoto, Osaka (JP); Shinya Shimizu, Osaka (JP); Tsuyoshi Eiza, Osaka (JP); Tetsuya Shihara, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/712,485

(22) Filed: Mar. 1, 2007

(30) Foreign Application Priority Data
Mar. 2, 2006 (JP) 2006-056339

(51) Int. Cl. G11B 7/00

(52) U.S. Cl. 369/44.29; 369/44.35

(57) ABSTRACT

An optical disc apparatus includes a spherical aberration correction element for correcting spherical aberration and a preadjustment unit for obtaining setting of a spherical aberration correction element for correcting spherical aberration appropriately in a case where a focus position of a light beam emitted from a light source is adjusted on each of recording layers of an optical recording medium every time when the optical recording medium is loaded to the apparatus.

This application is based on Japanese Patent Application No. 2006-056339 filed on Mar. 2, 2006, the contents of which are hereby incorporated by reference.

### BACKGROUND OF THE INVENTION

1. Field of the Invention

The present invention relates to an optical disc apparatus that is used for recording and reproducing information on an optical recording medium. In particular, the present invention relates to an optical disc apparatus that can support an optical recording medium having a plurality of recording layers.

2. Description of Related Art

Optical recording media including a compact disc (hereinafter referred to as a CD) and a digital versatile disc (hereinafter referred to as a DVD) are widely available. Furthermore, in order to increase a quantity of information recorded on the optical recording medium, researches on the high density of the optical recording medium are being carried on in recent years. For example, a high density optical recording medium such as a Blu-Ray Disc (hereinafter referred to as a BD) is being available in the market. Moreover, as to these optical recording media, there is also an optical recording medium having a plurality of recording layers in order to increase recording capacity further.

Recording and reproducing information on an optical recording medium is performed by using an optical disc apparatus, which is required to control a spot position of a light beam emitted from a light source to focus on a recording layer of the optical recording medium and to control the spot position of the light beam not to deviate from the recording layer during the recording or reproducing process. For this reason, the optical disc apparatus has an objective lens that can be driven by an actuator to move in a focus direction that is a direction substantially perpendicular to the recording layer of the optical recording medium. Furthermore, a focus position is adjusted by using a focus error signal that is obtained by processing an electric signal obtained by a photo detector that receives reflection light reflected by the optical recording medium.

At this point, when the actuator drives the objective lens to move toward the optical recording medium or away from the optical recording medium, an S shaped curve of the focus error signal is obtained as the focus position passes through the recording layer of the optical recording medium. In order to focus the spot position of the light beam emitted from the light source on the recording layer, this S shaped curve is used. More specifically, the objective lens is scanned in the focus direction, and pull-in of the focus is performed at a position where a signal value of the S shaped curve becomes zero so that the spot position of the light beam is focused on the recording layer.

In addition, when in a case the optical recording medium has a plurality of recording layers, S shaped curves of the focus error signal corresponding to the number of recording layers are obtained if the objective lens is moved in the direction of approaching toward the optical recording medium from a position away the optical recording medium. Therefore, as to an optical recording medium having a plurality of recording layers, a movement of a focus position of a light beam from one recording layer to another recording layer (hereinafter referred to also as a focus jump) is performed by a method of moving the objective lens in the direction of approaching toward the recording layer that is a destination of the movement and of deciding a position where the pull-in of the focus should be performed from the S shaped curve of the focus error signal that is obtained on this occasion so as to complete the focus jump.

However, since an optical disc apparatus supporting a high density optical recording medium such as a BD that will become the mainstream, uses an objective lens having a large numerical aperture (NA), it is considered that an influence of spherical aberration generated by a difference between transparent films on the recording layer will be very large when information is reproduced or recorded on an optical recording medium having a plurality of recording layers. Therefore, when the objective lens is moved by the actuator in the focus direction, clear S shaped curves may not always be detected corresponding to the number of recording layers of the optical recording medium unlike the conventional case.

Furthermore, if the S shaped curve can not be detected for each of the recording layers of the optical recording medium, a relationship between the S shaped curve and the recording layer becomes unclear in a case of performing the focus jump or other cases. This may cause a result that the focus jump cannot be completed with repeating retrying and finally the light beam spot cannot be focused on a desired recording layer.

Considering this point, JP-A-2004-39125 proposes an optical disc apparatus in which correction of spherical aberration is set in accordance with thickness of a light transmission protective layer (a cover layer) on a target recording layer, or correction of spherical aberration is set to a state where it is adjusted to an average vale of thicknesses of light transmission protective layers on a plurality of recording layers, before performing the focus jump, and that performs a focus searching operation for moving the objective lens in the optical axis direction and measures a polarity of the focus error signal and a level of a reflection light intensity signal that is produced as reflection light information so as to perform the focus pull-in. According to this structure, it is said that the focus pull-in can be performed securely on a target recording layer in an optical disc apparatus that uses an optical recording medium having a plurality of recording layers.

However, in a case of the optical disc apparatus described in JP-A-2004-39125, the setting value for correcting spherical aberration is determined on the precondition that thickness of the light transmission protective layer is uniform. Actually, thickness of a light transmission protective layer of an optical recording medium has a large variation, particularly in a case of an optical recording medium such as a BD that has a thin light transmission protective layer. Considering this fact and other factors such as influence of a tilt of the optical recording medium with respect to the optical axis, there may be a case where the S shaped curve cannot be detected and even a polarity of the focus error signal cannot be checked, so it cannot be said that the pull-in of the focus can be performed securely.

Moreover, in a case of a control method as described in JP-A-2004-39125, it is considered that a fairly strict requirement is necessary to a standard of an optical recording medium, while an optical disc apparatus is desired to be capable of having flexibility in standard of an optical recording medium. From this viewpoint too, the optical disc apparatus described in JP-A-2004-39125 cannot be said to be sufficient.

### SUMMARY OF THE INVENTION

In view of the above described problems, it is an object of the present invention to provide an optical disc apparatus that is capable of reproducing and recording information on an optical recording medium having a plurality of recording layers, which can support variation of the optical recording medium flexibly for performing a focus jump.

To attain the above described object, an optical disc apparatus in accordance with one aspect of the present invention includes: an objective lens for condensing a light beam emitted from a light source onto a recording layer of an optical recording medium; a light detection unit for receiving reflection light reflected by the recording layer and for converting light information of the reflection light into an electric signal;

a spherical aberration correction element disposed between the light source and the objective lens for performing correction of spherical aberration; and an actuator for moving the objective lens in the focus direction that is a direction substantially perpendicular to the recording layer. And the optical disc apparatus is characterized by a structure in which a focus position of the objective lens is moved by using the actuator from one recording layer to another recording layer of the optical recording medium after the spherical aberration correction element is set to a predetermined setting, and a preadjustment unit is provided for obtaining setting of the spherical aberration correction element for correcting spherical aberration appropriately in a case where the focus position is adjusted on the recording layer for each of the recording layers of the optical recording medium and for making the obtained setting be the predetermined setting every time when the optical recording medium is loaded to the apparatus.

In addition, the optical disc apparatus in accordance another aspect of the present invention having the above described structure, is also characterized by a structure in which an S shaped curve detection unit that collects signal information of a focus error signal obtained by processing the electric signal while moving the objective lens in the focus direction by the actuator and detects the S shaped curve of the focus error signal based on the collected signal information, and a spherical aberration correction information obtaining unit that changes setting of the spherical aberration correction element to a plurality of settings having different aberration correction quantities after the S shaped curve is detected, measures amplitude of the S shaped curve in each case of the settings, and obtains setting of the spherical aberration correction element for correcting spherical aberration appropriately in a case where the focus position is adjusted on the recording layer for each of the recording layers of the optical recording medium from the obtained amplitude information of the S shaped curve.

In addition, the optical disc apparatus in accordance other aspect of the present invention having the above described structure, is also characterized by a structure in which the spherical aberration correction information obtaining unit calculates an amplitude ratio of a plurality of S shaped curves in each case of the settings if the S shaped curve detection unit detects the plurality of S shaped curves, and obtains also information concerning the amplitude ratio of the S shaped curves and the setting of the spherical aberration correction element as the spherical aberration correction information, and if movement of the focus position is failed, the predetermined setting of the spherical aberration correction element is readjusted based on the amplitude ratio of the S shaped curve and the spherical aberration correction information when the failure happened.

In addition, the optical disc apparatus in accordance still other aspect of the present invention having the above described structure, is also characterized by a structure in which the preadjustment unit includes a signal gain adjustment block for adjusting a signal gain based on the amplitude value of the S shaped curve obtained by the S shaped curve detection unit.

In addition, the optical disc apparatus in accordance still other aspect of the present invention having the above described structure, is also characterized by a structure in which the S shaped curve detection unit starts time measurement at the same time as starting to collect the focus error signal, and if the collected focus error signal has a maximum value among the signals that have been collected before, time when the maximum value is collected and the maximum value are stored, and information concerning the maximum value is checked when the objective lens is moved by a predetermined distance in the focus direction and in one of the direction approaching toward the optical recording medium and the direction moving away from the optical recording medium, and if there is not the maximum value stored for longer than a predetermined time period, the information concerning the maximum value is reset, and further the objective lens is moved by a predetermined distance in the direction opposite to said one of the directions.

According to a first structure of the present invention, appropriate correction quantity for correcting spherical aberration is obtained for each of the recording layers of the optical recording medium by the preadjustment unit in advance for each optical recording medium. Therefore, it is possible to reduce possibility of failure in detecting the S shaped curve of a destination of focus jump and performing the focus jump.

In addition, according to the second structure of the present invention, it is possible to realize easily a preadjustment unit that can reduce possibility of failure in the focus jump as to the optical disc apparatus having the first structure described above.

In addition, according to the third structure of the present invention, even if the focus jump is failed, the focus jump is retried and can be completed successfully at high probability as to the optical disc apparatus having the second structure described above.

In addition, according to the fourth structure of the present invention, as to the optical disc apparatus having the second or the third structure described above, it is possible to measure the amplitude of the S shaped curve correctly so that a stable focus jump environment can be secured.

In addition, according to the fifth structure of the present invention, as to the optical disc apparatus having any one of the second to the fourth structures described above, it is possible to realize a structure for detecting the S shaped curve securely even if a signal level is low.

### BRIEF DESCRIPTION OF THE DRAWINGS

FIG. 1 is a block diagram to show a structure of an optical disc apparatus according to the present invention.

FIG. 2 is a schematic diagram of an optical system of an optical pickup that is provided to the optical disc apparatus shown in FIG. 1.

FIG. 3 is a schematic cross sectional view of an optical recording medium having two recording layers.

FIGS. 4A and 4B are explanatory diagrams of a structure of a liquid crystal element that is provided to the optical disc apparatus shown in FIG. 1.

FIG. 5 is a diagram to show schematically a focus error signal that is obtained when an objective lens is driven by the actuator to move in the direction of approaching toward a two-layer disc.

FIG. 6 is a block diagram to show a structure of a preadjustment unit of a first embodiment that is provided to the optical disc apparatus according to the present invention.

FIG. 7 is a flowchart to show preadjustment performed by the preadjustment unit of the first embodiment.

FIG. 8 is a flowchart to show a procedure of detection of an S shaped curve performed by an S shaped curve detection unit.

FIGS. 9A and 9B are schematic diagrams to show a relationship between a displacement of the objective lens and a focus error signal that is generated along with the displacement as to the two-layer disc.

FIG. 10 is a flowchart to show preadjustment performed by a preadjustment unit of a second embodiment that is provided to the optical disc apparatus according to the present invention.

FIG. 11 is a flowchart to show a process flow in a case where focus jump is performed from a second layer to a first layer.

### DETAILED DESCRIPTION OF THE PREFERRED EMBODIMENTS

Although contents of the present invention are described in detail hereinafter, the embodiment described hereinafter is merely an example, so that the present invention should not be interpreted to be limited to the embodiment.

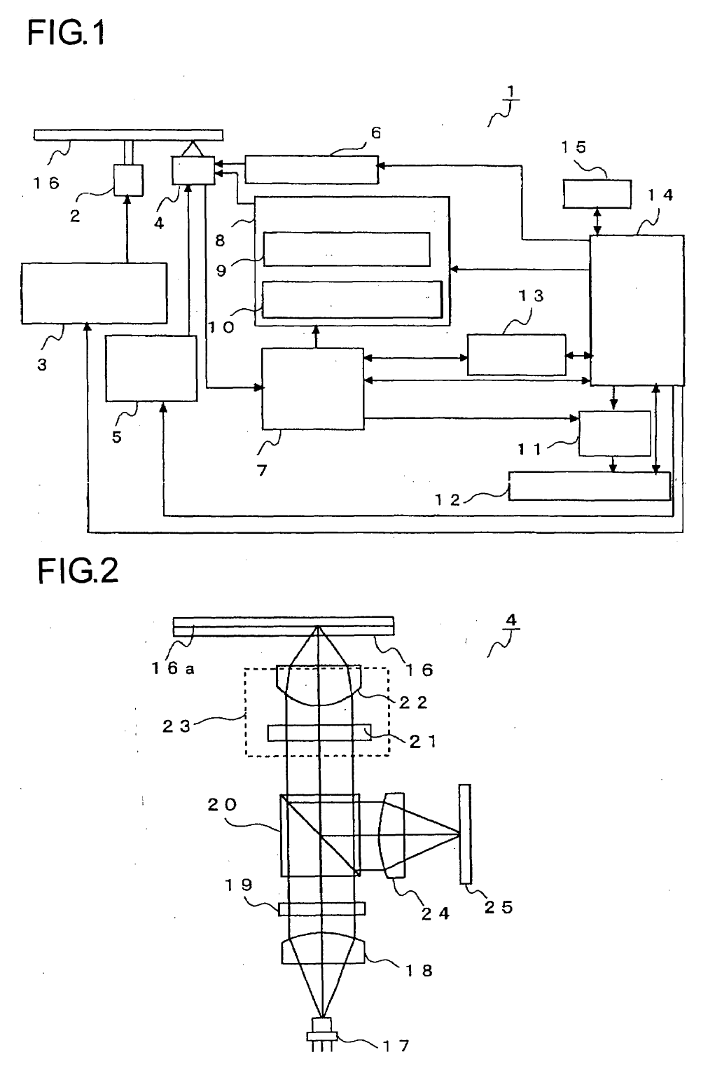

FIG. 1 is a block diagram to show a structure of an optical disc apparatus according to the present invention. An optical disc apparatus 1 can reproduce information from an optical recording medium 16 and can record information on the optical recording medium 16. At this point, the optical disc apparatus 1 of the present embodiment can record and reproduce information on the optical recording medium 16 having a single recording layer and on the optical recording medium 16 having two recording layers.

Numeral 2 denotes a spindle motor, and the optical recording medium 16 is retained in a removable manner by a chucking portion (not shown) that is provided to an upper portion of the spindle motor 2. When information is recorded or reproduced on the optical recording medium 16, the spindle motor 2 rotates the optical recording medium 16 continuously. Rotation control of the spindle motor 2 is performed by a spindle motor control unit 3.

Numeral 4 is an optical pickup that projects a light beam emitted from a light source 17 to the optical recording medium 16 so that information can be written on the optical recording medium 16 and that information recorded on the optical recording medium 16 can be read. FIG. 2 is a schematic diagram of an optical system of the optical pickup 4. As shown in FIG. 2, in the optical pickup 4, the light beam emitted from the light source 17 that is a semiconductor laser is converted into parallel rays by a collimator lens 18 and is divided into three beams including a main beam and a sub beam by a diffraction element 19 so as to obtain a tracking error signal that will be described later. Then, the beams pass through a beam splitter 20, pass through a liquid crystal element 21 that is a spherical aberration correction element, and are condensed by an objective lens 22 onto a recording layer 16a of the optical recording medium on which information if recorded.

Reflection light reflected by the optical recording medium 16 passes through the objective lens 22 and the liquid crystal element 21 in this order and is reflected by the beam splitter 20 so as to be condensed by a condenser lens 24 onto a light receiving portion (not shown) of a photo detector 25. The photo detector 25 receives the reflection light and converts light information of the reflection light into an electric signal, which is supplied to a signal processing unit 7 (see FIG. 1).

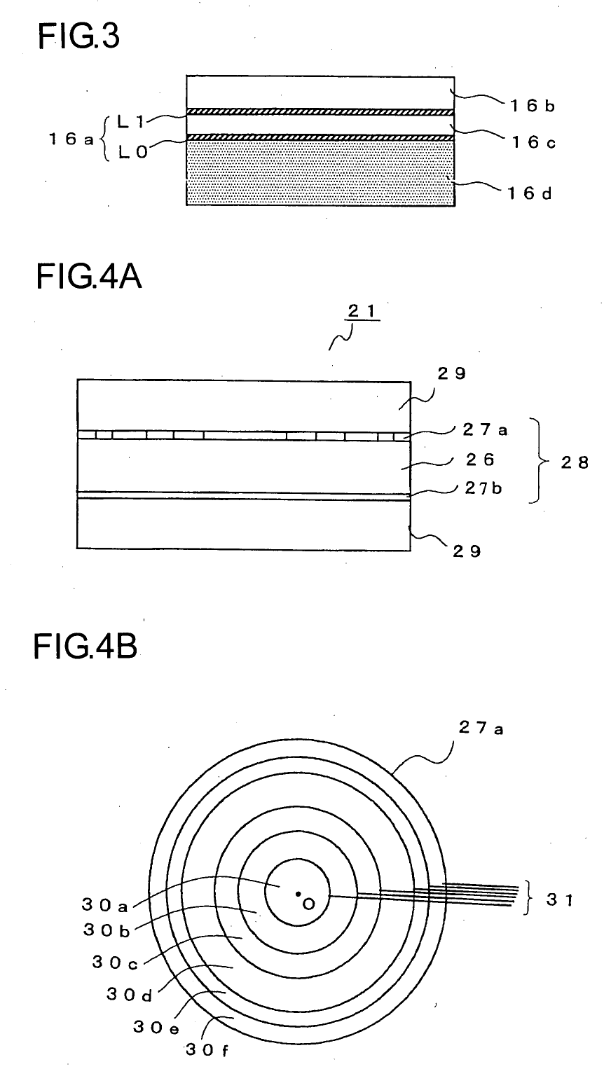

The liquid crystal element 21 that is provided to the optical pickup 4 will be described in detail as below. FIG. 3 is a schematic cross sectional view of an optical recording medium having two recording layers (hereinafter may be referred to as a two-layer disc). As shown in FIG. 3, the two-layer disc has a structure in which a substrate 16d, a recording layer L0 (a first layer), a transparent intermediate layer 16c, a recording layer L1 (a second layer), and a transparent protective layer 16b are disposed in this order from the lower side.

Since the two-layer disc has the intermediate layer 16c, thickness of transparent resin disposed on the recording layer is different between the first layer L0 and the second layer L1, so there will be a problem of generation of spherical aberration. More specifically, spherical aberration cannot be neglected when a focus jump of a focus position of the light beam emitted from the light source 17 is performed from the second layer L1 to the first layer L0 for example, so there is a case where the focus point of the light beam from the light source 17 cannot be adjusted on the first layer L0.

The spherical aberration that is generated due to a difference between thicknesses of the intermediate layer and the protective layer on the recording layer will becomes a problem particularly in a case where a numerical aperture (NA) of the objective lens 22 is increased for supporting a high density optical recording medium such as a BD. In order to correct the spherical aberration, a spherical aberration correction element such as a liquid crystal element 21 becomes necessary. For this reason, the liquid crystal element 21 is disposed in the optical system of the optical pickup 4 so that the spherical aberration can be corrected.

FIGS. 4A and 4B are explanatory diagrams of a structure of liquid crystal element 21 that is provided to the optical pickup 4. FIG. 4A is a schematic cross sectional view to show a structure of the liquid crystal element 21, and FIG. 4B is a plan view of the liquid crystal element 21 shown in FIG. 4A viewed from the top. As shown in FIG. 4A, the liquid crystal element 21 includes a liquid crystal 26, two transparent electrodes 27a and 27b that sandwich the liquid crystal 26, and two glass plates 29 that sandwich a portion 28 including the liquid crystal 26 and the transparent electrodes 27a and 27b.

As shown in FIG. 4B, the transparent electrode 27a that constitutes the liquid crystal element 21, is divided into a plurality of concentric circular areas 30a-30f. In contrast, the transparent electrode 27b that is opposed to the transparent electrode 27a is not divided but is a common electrode as a whole. Since the transparent electrodes 27a and 27b are structured as described above, when a voltage is applied between the transparent electrodes 27a and 27b for driving the liquid crystal element 21, a desired phase difference is generated in the light beam that passes through the liquid crystal element 21 so that the spherical aberration can be corrected.

At this point, the transparent electrode 27b may be divided into a plurality of concentric circular areas in the same manner as the transparent electrode 27a. In addition, the transparent electrodes 27a and 27b are connected electrically via lead wires 31 to a liquid crystal element control unit 6 (see FIG. 1), which controls a drive voltage to be applied to the transparent electrodes 27a and 27b.

With reference to FIG. 1 again, the optical disc apparatus 1 is equipped with the signal processing unit 7, which includes at least an RF signal processing portion, a tracking error signal processing portion and a focus error signal processing portion (they are all not shown). Furthermore, the signal processing unit 7 produces an RF signal, a tracking error signal (TE signal) and a focus error signal (FE signal) based on the electric signal that is converted by the photo detector 25 (see FIG. 2). The RF signal is decoded by a data decoding unit 11 into a data, which is supplied to an external device such as a personal computer via an interface 12.

An actuator control unit 8 includes a focus control block 9 and a tracking control block 10. An actuator 23 that carries the liquid crystal element 21 and the objective lens 22 and moves them (see FIG. 2 for both) is controlled by the focus control block 9 so that the objective lens 22 is moved in the focus direction that is a direction perpendicular to the recording layer of the optical recording medium 16 (vertical direction in FIG. 2). The tracking control block 10 controls the actuator 23 so as to move the objective lens 22 in the tracking direction that is the radial direction of the optical recording medium 16 (horizontal direction in FIG. 2).

Then, the actuator control unit 8 performs servo control that includes focusing control for focusing the objective lens 22 for the recording layer of the optical recording medium 16 and tracking control for adjusting a spot position of the light beam to a tracking position formed on the optical recording medium 16 based on the TE signal and the FE signal.

Other than that, a laser control unit 5 controls laser output power of the light source 17 that is made up of a semiconductor laser provided to the optical pickup 4. In addition, a general control unit 14 performs the entire control of the apparatus by controlling the spindle motor control unit 3, the laser control unit 5, the liquid crystal element control unit 6, the signal processing unit 7, the actuator control unit 8, the data decoding unit 11, the interface 12, a preadjustment unit 13 that will be described later, a storage unit 15 for storing information that is necessary for control, and the like.

Next, the preadjustment unit 13 that is provided to the optical disc apparatus 1 will be described. The preadjustment unit 13 obtains setting of liquid crystal element 21 for correcting spherical aberration appropriately for each of recording layers of the optical recording medium 16 every time when the optical disc apparatus 1 is loaded with the optical recording medium 16. First, the reason why the preadjustment by this preadjustment unit 13 is necessary will be described.

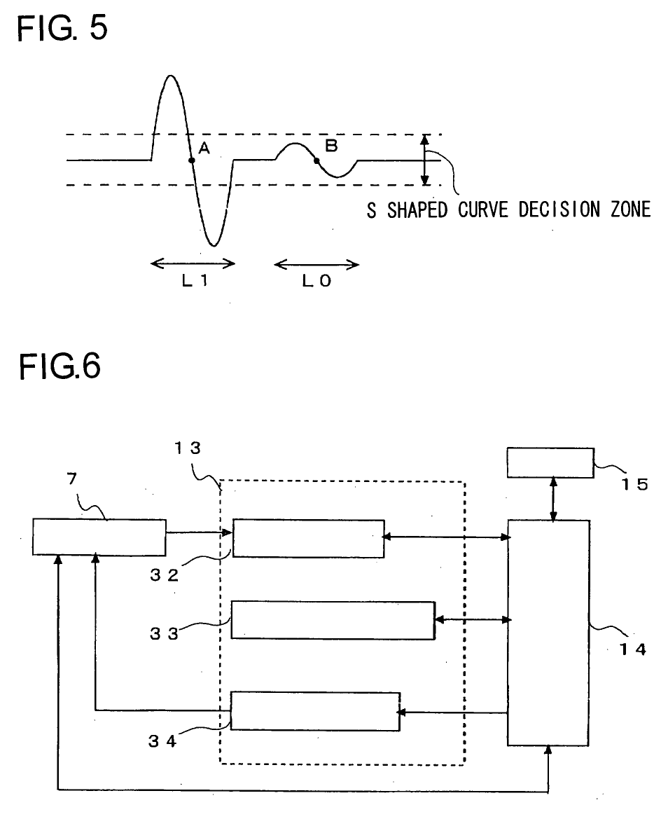

FIG. 5 is a diagram to show schematically a focus error signal that is obtained when the objective lens 22 is driven by the actuator 23 to move in the direction of approaching toward a two-layer disc. When the focus position of the light beam emitted from the light source 17 passes through the second layer L1 and the first layer L0 (see FIG. 3 for both), the S shaped curve is obtained as shown in FIG. 5. Furthermore, the positions where the focus error signal becomes zero in this S shaped curve (corresponding to the positions A and B in FIG. 5) indicate the sate where the light beam is focused appropriately on the recording layer.

In order to pull in the focus position on the recording layer of the optical recording medium 16, this S shaped curve is utilized. This process will be described with an example of the case of performing the focus jump of the light beam emitted from the light source 17 from the second layer L1 to the first layer L0 when information is reproduced or recorded on a two-layer disc by using the optical disc apparatus 1.

When the focus jump is performed from the second layer L1 to the first layer L0, the actuator 23 first moves the objective lens 22 in the direction of approaching toward the optical recording medium 16. On this occasion, the focus error signal indicates a signal that presents on the right side of the position A in FIG. 5. Then, the focus position of the light beam approaches the first layer L0. When the signal becomes zero (corresponding to the position B in FIG. 5) after passing through the maximum value corresponding to the first layer L0 in the S shaped curve, the pull-in of the focus on the first layer L0 is performed, and the focus jump is completed.

However, due to presence of spherical aberration, there is a case where a signal level of the S shaped curve of the recording layer that is a destination of the focus jump (the first layer L0 in FIG. 5) may be decreased so as to be below an S shaped curve decision zone shown in FIG. 5. In such case, the S shaped curve cannot be detected so that the focus jump is failed. For this reason, there is a conventional method of performing the focus jump after changing a setting value of the liquid crystal element 21 so that the spherical aberration on the first layer L0 that is a destination of the focus jump can be corrected before the focus jump is performed.

However, even if the above-mentioned setting value of the liquid crystal element 21 is stored in the storage unit 15 (see FIG. 1) or the like in advance when the optical disc apparatus 1 is manufactured and the setting value of the liquid crystal element 21 is made to be the stored setting value when the focus jump is performed, the S shaped curve of the recording layer that is a destination of the focus jump may become a signal level lower than the S shaped curve decision zone due to variation of thickness of a transparent film such as a protective layer 16b or the intermediate layer 16c of the optical recording medium 16. In this case, the focus jump may be failed.

For this reason, the preadjustment unit 13 is provided for obtaining in advance the setting value of the liquid crystal element 21 for correcting spherical aberration appropriately for each of the recording layers of the optical recording medium 16 with respect to each optical recording medium 16 that is loaded to the optical disc apparatus 1, so that the obtained setting value can be adopted when the focus jump is performed.

Next, a structure of the preadjustment unit 13 of the first embodiment according to the present invention will be described with reference to FIG. 6. FIG. 6 is a block diagram to show a structure of the preadjustment unit 13 of the first embodiment. The preadjustment unit 13 includes an S shaped curve detection block 32, a spherical aberration correction information obtaining block 33, and a signal gain adjustment block 34. Hereinafter, each block will be described.

The S shaped curve detection block 32 fetches the focus error signal that is obtained when the objective lens 22 is moved by the actuator 23 (see FIG. 2 for both) in the focus direction and is processed in the signal processing unit 7 together with time (measured time) from the start of collection of the signal, and stores them in the storage unit 15. Then, it detects the S shaped curve from signal information of the collected focus error signal. The method of detecting the S shaped curve will be described later. At this point, the focus direction includes both of the direction of moving the objective lens 22 to approach the optical recording medium 16 and the direction of moving the same away from the optical recording medium 16.

The spherical aberration correction information obtaining block 33 changes a voltage value for driving the liquid crystal element 21 to a plurality of setting values to be different aberration correction quantities after the S shaped curve is detected by the S shaped curve detection block 32, measures amplitude values of the detected S shaped curves in each case of setting values, and stores the measurement result in the storage unit 15. Then, it obtains the setting value of the liquid crystal element 21 for correcting the spherical aberration appropriately in a case where the focus position of the light beam emitted from the light source 17 is adjusted on each of the recording layers from amplitude information of the S shaped curve. The obtained setting value of the liquid crystal element 21 is stored in the storage unit 15 and is used when the pull-in of the focus point on each recording layer is performed including when the focus jump is performed.

If there is the S shaped curve that is detected by the S shaped curve detection block 32 and whose signal level is lower than a predetermined level, the signal gain adjustment block 34 performs signal gain adjustment so that the S shaped curve can be detected securely in the subsequent decision of the setting value of the liquid crystal element 21 by the spherical aberration correction information obtaining block 33. The adjustment value determined by the signal gain adjustment block 34 is supplied to the signal processing unit 7.

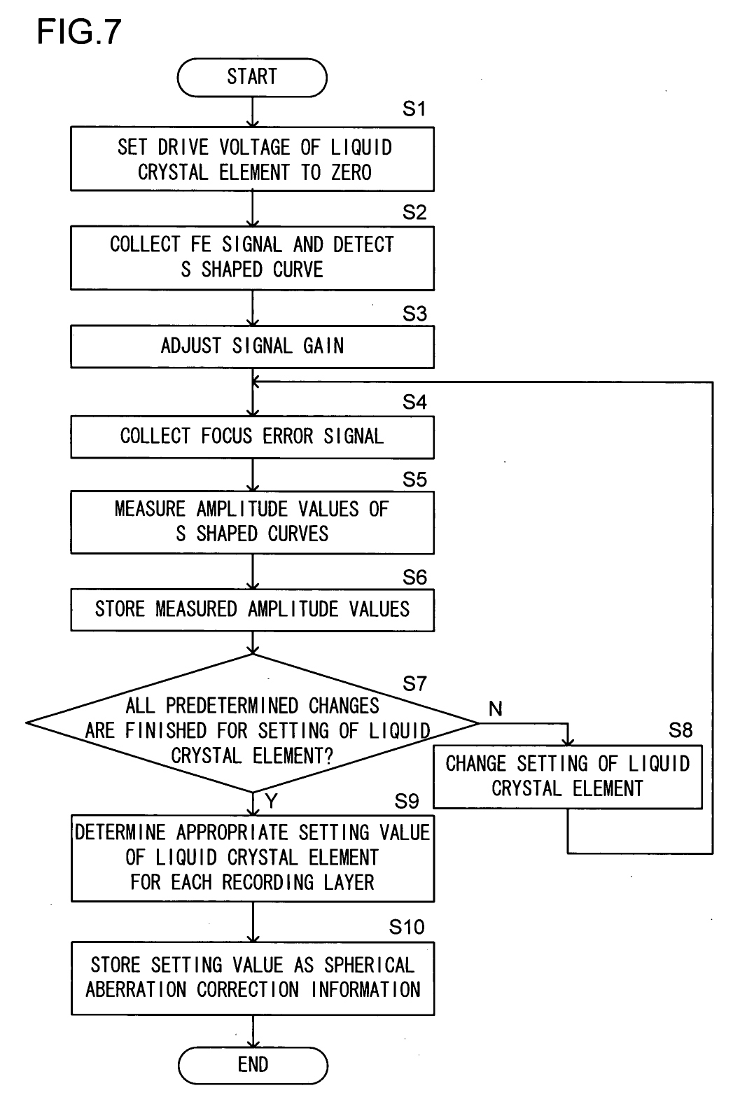

The preadjustment performed by the preadjustment unit 13 of the first embodiment having the structure described above will be described with reference to a flowchart shown in FIG. 7. At this point, this preadjustment is performed every time when the optical disc apparatus 1 is loaded with the optical recording medium 16, and that the timing thereof may be just after the loading of the optical recording medium or may be just before information is recorded or reproduced on the optical recording medium 16 without any limitation.

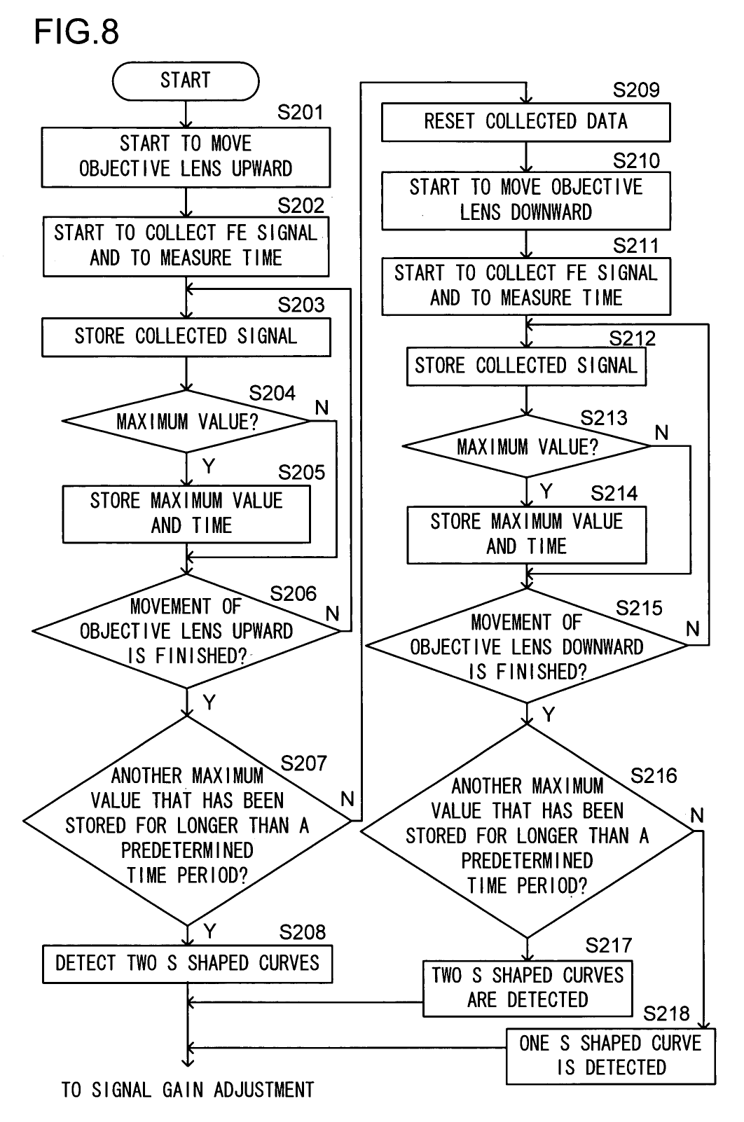

First in the preadjustment, a drive voltage of the liquid crystal element 21 is set to zero (Step S1). In other words, correction of spherical aberration is not performed at this step. Next, the S shaped curve detection block 32 starts to collect information of the focus error signal, and the S shaped curve is detected based on the obtained information (Step S2). Hereinafter, prior to description of the step S3 and subsequent steps, a detailed procedure until the S shaped curve detection block 32 detects the S shaped curve in this step S2 will be described with reference to the flowchart shown in FIG. 8.

The S shaped curve detection block 32 first starts to move the objective lens 22 in the direction of approaching toward the optical recording medium 16 (upward direction) (Step S201). At the same time, it starts to collect the focus error signal (FE signal) and to measure time (Step S202). The collected signal and the measured time are stored in the storage unit 15 (Step S203). It is checked whether or not the stored signal is a maximum value (Step S204). If the checked signal value is a maximum value, the maximum value and the time when the maximum value is collected (corresponding time) are stored in the storage unit 15 (Step S205). It is checked whether or not the objective lens 22 reaches a specified position in the upward direction so that the movement of the objective lens 22 in the upward direction is finished (Step S206). If the movement of the objective lens 22 in the upward direction is not finished, the process from the step S203 to the step S206 is repeated.

At this point, moving range of the objective lens 22 in the upward direction is not limited to a specific range as long as the focus position of the light beam emitted from the light source 17 can traverse all the recording layers of the optical recording medium 16 within the range when the objective lens 22 is moved upward.

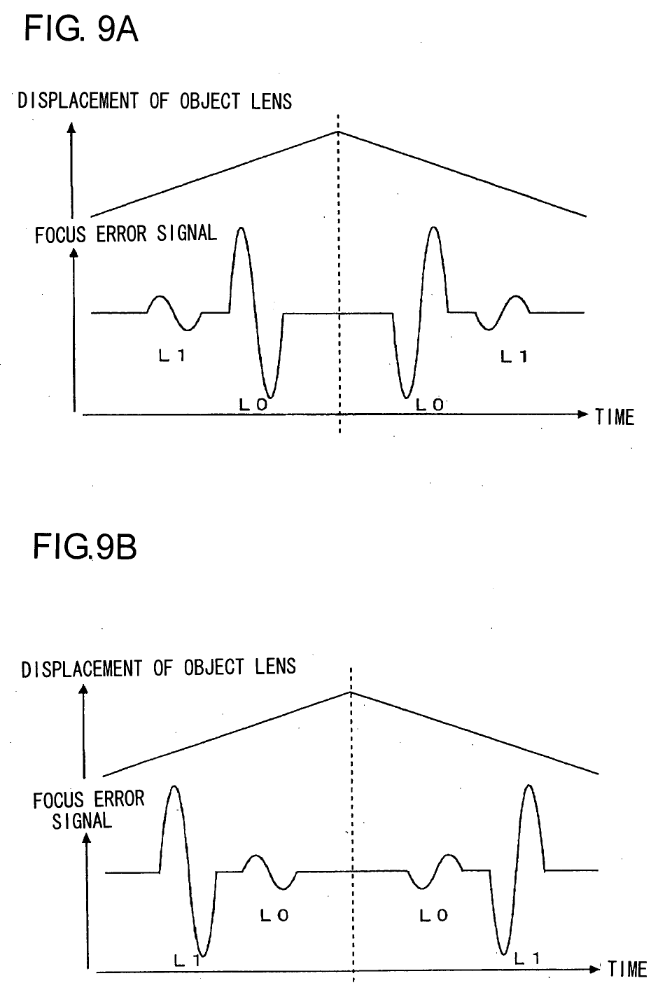

Prior to describing the step S207 and the subsequent steps, a concept of the following operation will be described. FIGS. 9A and 9B are schematic diagrams to show a relationship between a displacement of the objective lens 22 and a focus error signal that is generated along with the displacement with an example of a two-layer disc. Furthermore, FIG. 9A shows the case where the first layer L0 (see FIG. 3) disposed at the side farther from the objective lens 22 can give a larger S shaped curve, and FIG. 9B shows the case where the second layer L1 (see FIG. 3) disposed at the side nearer to the objective lens 22 can give a larger S shaped curve.

When the movement of the objective lens 22 in the upward direction is finished in the step S206, the signal of the left side of the broken line in FIG. 9A or the signal of the left side of the broken line in FIG. 9B is obtained. In a case where the signal as shown in FIG. 9A is obtained, information concerning a maximum value is stored in the order of the second layer L1 and the first layer L0 by the operation from the step S201 to the step S206 because amplitude of the S shaped curve is larger on the first layer L0 than on the second layer L1. Therefore, two S shaped curves can be detected by analyzing the stored information of the maximum value.

However, in a case where the signal as shown in FIG. 9B appears, a part of the S shaped curve on the first layer L0 that becomes maximum is not decided to be the maximum value nor stored by the operation from the step S201 to the step S206 after the maximum value on the second layer L1 is stored because amplitude of the S shaped curve on the second layer L1 is larger than amplitude of the S shaped curve on the first layer L0. Therefore, even in a case where two S shaped curves should be obtained, the second S shaped curve cannot be detected so that it is decided to be a single layer. Considering this point, the step S207 and subsequent steps are performed. Hereinafter, the following steps in the flowchart will be described with reference to FIG. 8 again.

When the movement of the objective lens in the upward direction is finished, it is checked whether or not there is another maximum value that has been stored for longer than a predetermined time period that is determined based on time necessary for the objective lens 22 to move from the second layer L1 to the first layer L0 of the two-layer disc (e.g., time a little shorter than time necessary for moving from L1 to L0) (Step S207). If there is another maximum value that has been stored for longer than a predetermined time period, it indicates that two S shaped curves are detected (Step S208). More specifically, in the step S208, it is decided whether the situation of the left side in FIG. 9A appears. In this case, the maximum value on the second layer L1 depends on that the memory is kept for longer than a predetermined time period until the maximum value on the first layer L0 is detected. At this point, it is possible to adopt a structure for storing a data indicating that the optical recording medium 16 loaded to the optical disc apparatus 1 is a two-layer disc.

If there is not another maximum value that has been stored for longer than a predetermined time period, it indicates either the situation of the left side in FIG. 9B or that the optical recording medium 16 is a single layer disc. In this case, the data in the storage unit 15 that was stored when the objective lens 22 was moved in the upward direction is reset (erased) (Step S209), and movement of the objective lens 22 is started in the direction of moving away from the optical recording medium 16 (downward direction) (Step S210). Furthermore, at the same time, collection of the focus error signal (FE signal) and measurement of time are started (Step S211). At this point, it is possible to adopt a structure in which the collection of the focus error signal and the measurement of time are performed continuously without stopping around the time when the movement of the objective lens 22 is switched from the upward direction to the downward direction.

The collected signal and the measured time are stored in the storage unit 15 (Step S212). It is checked whether or not the stored signal is a maximum value (Step S213). If the checked signal value is a maximum value, the maximum value and the time when the maximum value is collected are stored in the storage unit 15 (Step S214). It is checked whether or not the objective lens 22 reaches a specified position in the downward direction so that the movement of the objective lens 22 in the downward direction is finished (Step S215). If the movement of the objective lens 22 in the downward direction is not finished yet, the process from the step S212 to the step S215 is repeated.

At this point, the moving range of the objective lens 22 in the downward direction is not limited to a specific range in the same manner as the case of the movement in the upward direction, as long as the focus position of the light beam emitted from the light source 17 can traverse all the recording layers of the optical recording medium 16 within the range when the objective lens 22 is moved downward.

When the movement of the objective lens 22 in the downward direction is finished, it is checked whether or not there is another maximum value that has been stored for longer than a predetermined time period that is determined based on time necessary for the objective lens 22 to move from the second layer L0 to the first layer L1 of the two-layer disc (e.g., time a little shorter than time necessary for moving from L0 to L1) (Step S216). If there is another maximum value that has been stored for longer than a predetermined time period, it indicates that two S shaped curves are detected (Step S217). More specifically, the right side in FIG. 9B shows the same situation as the left side in FIG. 9A with the opposite phase. On the contrary, if there is not another maximum value that has been stored for longer than a predetermined time period, it indicates that only one S shaped curve is detected (Step S218). In other words, it is decided that the optical recording medium 16 is a single layer disc. At this point, it is possible to adopt a structure in which it is decided whether the disc is a two-layer disc or a single layer disc based on the result corresponding to the number of the S shaped curves and the decision result is stored.

According to the operation described above, even if the signal level of the S shaped curve becomes very low due to a factor of spherical aberration or the like, the S shaped curve of the recording layers can be detected securely. At this point, the process flow using the S shaped curve detection block 32 until the S shaped curve is detected is not limited to the structure described above but can be modified variously within the spirit and the cope of the present invention without deviating from its object. For example, although the present embodiment adopt the structure in which the objective lens 22 is moved in the upward direction and then is moved in the downward direction, it is possible to adopt the structure in which the objective lens 22 is moved in the downward direction and then is moved in the upward direction.

Furthermore, unlike the structure described above, it is possible to decide whether or not the collected signal is a relative maximum value (not the maximum value such as the greatest value) in comparison with a data before or after so that two S shaped curves can be obtained securely by the movement in one direction upward or downward. However in actual measurement, because the colleted values are always fluctuating and to clearly judge the relative maximum may require a circuit for smoothing, it may introduce much complicated structure.

With reference to FIG. 7 again, a process flow after the S shaped curve is detected (Step S2) will be described. If the signal level of the S shaped curve detected in the step S2 is lower than a predetermined reference that is decided to be necessary at least for checking the S shaped curve, the signal gain adjustment block 34 supplies a signal to the signal processing unit 7 so that the signal gain adjustment is performed (Step S3).

At this point, although the adjustment of the signal gain is not always required to be performed, it is preferable to perform the signal gain adjustment by using the signal gain block 34 so that the S shaped curve can be detected easily in the later measurement of amplitude of the S shaped curve or the like.

After that, the spherical aberration correction information obtaining block 33 performs collection of the focus error signal (Step S4) and measurement of amplitude values of the detected S shaped curves (Step S5). The measured amplitude values are stored together with the setting of liquid crystal element 21 in the storage unit 15 (Step S6). At this point, the spherical aberration correction information obtaining block 33 can detect the S shaped curve clearly by the signal gain adjustment at the stage after the signal gain adjustment, and therefore it is not always necessary that the detection of the S shaped curve is performed according to the process flow shown in FIG. 8. It is possible to adopt a structure of moving the objective lens 22 only in the upward direction or in the downward direction so that the S shaped curve is detected from the obtained signal. It is also possible to perform the detection of the S shaped curve again by the S shaped curve detection block 32 according to the process flow shown in FIG. 8.

After that, it is checked whether or not all the predetermined changes that were scheduled are finished concerning the change of setting of the liquid crystal element 7 (Step S7). If all the predetermined changes are not finished, the drive voltage of the liquid crystal element 21 is changed (Step S8). Then, the process from the step S4 to the step S8 is repeated until all the predetermined changes are finished.

At this point, it is considered that the signal level of the S shaped curve may be lowered to be below a detectable level when the drive voltage of the liquid crystal element 21 is changed. Therefore, it is possible to add another process flow in which if a desired number of S shaped curves are not obtained in the measurement of amplitude of the S shaped curve (Step S4), the detection of the S shaped curve is performed again according to the flowchart shown in FIG. 8 so that the signal gain adjustment block 34 performs the signal gain adjustment.

On the contrary, if all the predetermined changes are finished with respect to the change of setting of the liquid crystal element 7, the spherical aberration correction information obtaining block 33 determines the setting value of the liquid crystal element 21 for correcting spherical aberration appropriately with respect to each of the recording layers of the optical recording medium 16 based on the amplitude value of the obtained focus error signal (Step S9). The determined setting value is stored as spherical aberration correction information in the storage unit 15 (Step S10).

As described above, the preadjustment unit 13 of the first embodiment obtains an appropriate setting value for the liquid crystal element 21 to correct the spherical aberration with respect to each of the recording layers of the optical recording medium 16 every time when the optical disc apparatus 1 is loaded with an optical recording medium 16. Therefore, when the focus jump is performed, the setting value of the liquid crystal element 21 is made to be a value corresponding to the recording layer that is a destination of the focus jump obtained by the preadjustment, and after that the focus jump is performed. Thus, possibility of failure in the focus jump due to a low signal level of the S shaped curve can be reduced.

Next, the preadjustment unit of the second embodiment that is provided to the optical disc apparatus according to the present invention will be described. The preadjustment unit 13 of the first embodiment is not structured on an assumption of the case where the focus jump is failed, but the preadjustment unit 13 of the second embodiment is structured on the assumption of the case where the focus jump is failed. As to description of the preadjustment unit 13 of the second embodiment, a part the description overlapping with that of the preadjustment unit 13 of the first embodiment will be omitted for convenience sake.

The preadjustment unit 13 of the second embodiment also includes the S shaped curve detection block 32, the spherical aberration correction information obtaining block 33 and the signal gain adjustment block 34 similarly to the case of the first embodiment. However, the operation of the spherical aberration correction information obtaining block 33 is different.

More specifically, the spherical aberration correction information obtaining block 33 of the first embodiment detects the S shaped curves and then evaluates amplitude values of the S shaped curves, so that a result of the evaluation is stored in the storage unit 15. The spherical aberration correction information obtaining block 33 of the second embodiment calculates an amplitude ratio between two S shaped curves in a case where two S shaped curves are detected (corresponding to the case of a two-layer disc) and stores the amplitude ratio too in the storage unit 15.

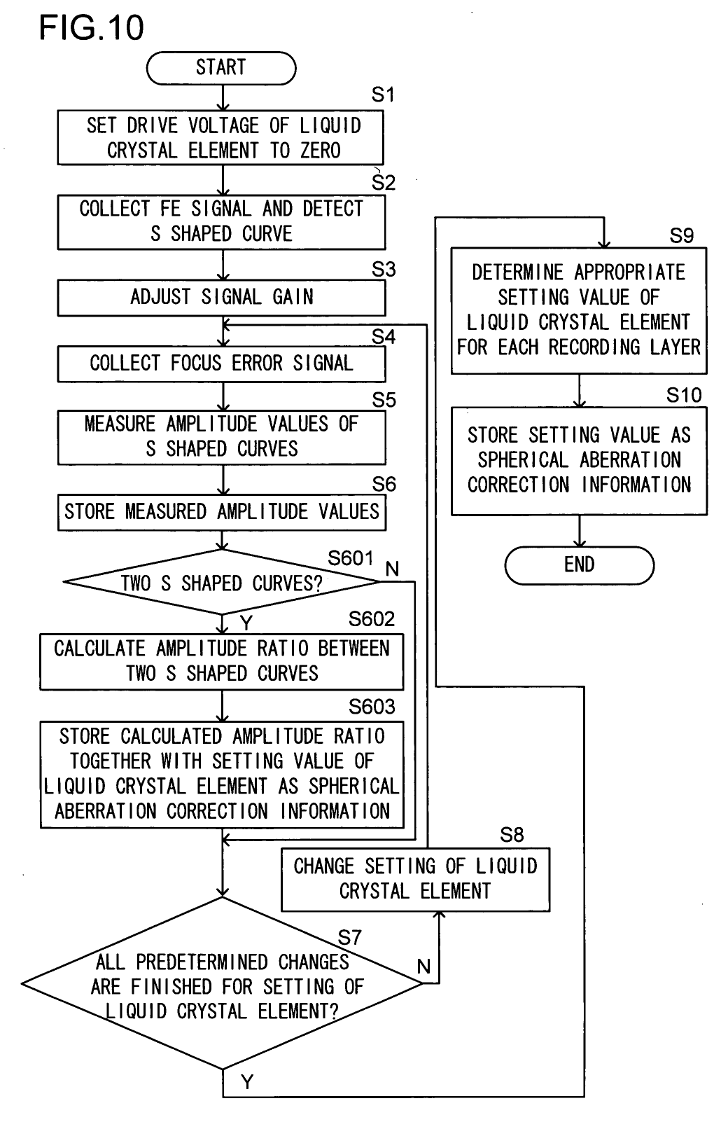

FIG. 10 is a flowchart to show preadjustment flow performed by the preadjustment unit 13 of the second embodiment. At this point, steps shown in FIG. 10 that perform the same operations as in the first embodiment are denoted by the same step numbers, and descriptions thereof are omitted.

The second embodiment is different from the first embodiment in that three steps S601 to S603 are inserted between the step S6 and the step S7. After amplitudes of S shaped curves are measured and stored (Step S6), it is checked first whether or not two S shaped curves are detected (Step S601). On this occasion, if two S shaped curves are detected, an amplitude ratio between the two S shaped curves is calculated (Step S602). Then, the calculated amplitude ratio is stored together with the setting value of the drive voltage of the liquid crystal element 21 at that time point in the storage unit 15 as spherical aberration correction information (Step S603). On the contrary, if only one S shaped curve is detected, the disc is a single layer optical recording medium. Therefore, the process goes to the step S7 without calculating the amplitude ratio.

At this point, although the present embodiment adopts the structure in which only the setting values of liquid crystal element 21 and the amplitude ratio between the S shaped curves of the setting values are stored as information concerning the amplitude ratio between the S shaped curves, the present invention is not limited to this structure. For example, it is possible to adopt a structure in which an amplitude ratio between the S shaped curves is calculated also with respect to a part that is not measured based on the measured information by using linear interpolation or the like.

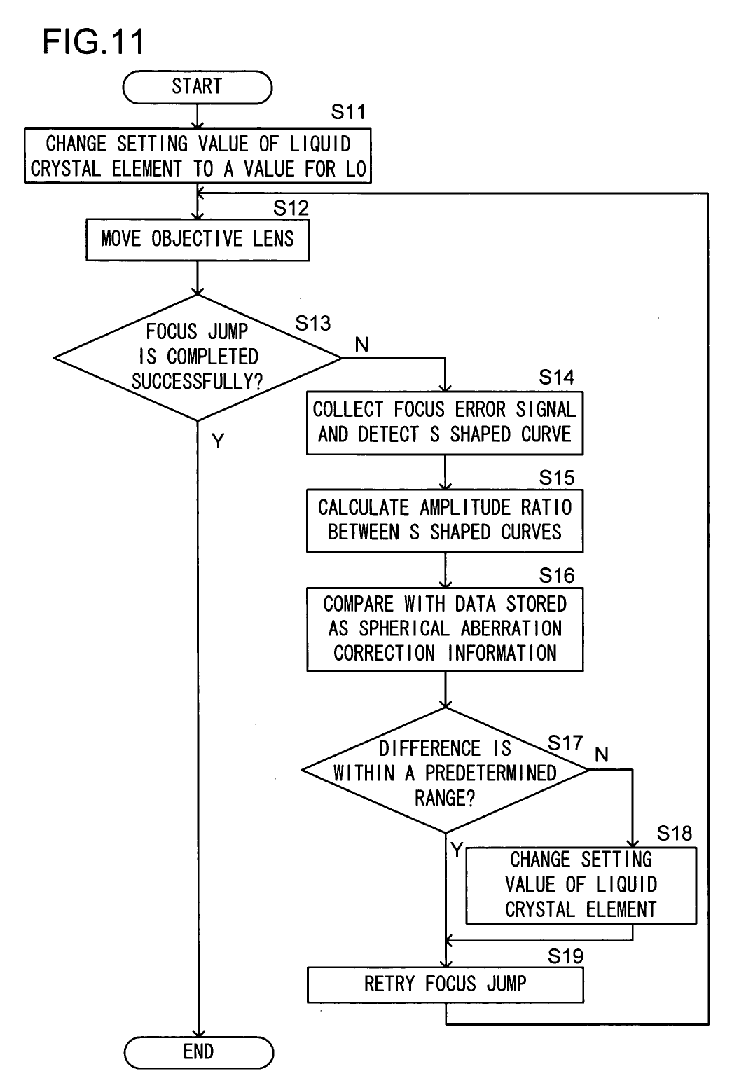

In this way, the preadjustment unit 13 stores the setting of the liquid crystal element 21 and the amplitude ratio between the S shaped curves of the respective recording layers in that case are stored, so that retrying in a case where the focus jump is failed can be completed successfully at very high probability. This point will be described with reference to FIG. 11. At this point, FIG. 11 is a flowchart to show a process flow in a case where the focus jump is performed from the second layer L1 to the first layer L0 (see FIG. 3 for both).

When the focus jump from the first layer L1 to the second layer L0 is performed, the setting value of the liquid crystal element 21 is changed first from the setting value for the second layer L1 to the setting value for the first layer L0 (each of them is the setting value obtained by the preadjustment unit 13) (Step S11). Thus, in general, the signal of the S shaped curve that corresponds to the first layer L0 that is a destination of the focus jump can be detected easily. Next, the actuator 23 (see FIG. 2) moves the objective lens 22 in the direction toward the first layer L0 that is a destination of the focus jump (Step S12). More specifically, pull-in timing to the first layer L0 is measured by signal change of the focus error signal. If the S shaped curve on the first layer L0 is detected, the pull-in of the focus is performed at a zero cross point of the S shaped curve so that the focus jump is completed successfully.

Although the focus jump operation is finished when it is completed successfully, still there may be a case where the focus jump is failed. For this reason, it is checked whether or not the focus jump is completed successfully (Step S13). If the focus jump is failed, the S shaped curve detection block 32 detects the S shaped curve according to the process flow shown in FIG. 8 (Step S14).

If the S shaped curve is detected, amplitude values of the respective S shaped curves are measured so that the amplitude ratio between the S shaped curves is calculated (Step S15). At this point, it is possible to perform the signal gain adjustment by the signal gain adjustment block 34 before the step S15 is performed. After the amplitude ratio between the S shaped curves is calculated, it is compared with the amplitude ratio between S shaped curves in a case of the same setting of the liquid crystal element among information stored as the spherical aberration correction information in the storage unit 15 (Step S16). Then, after the comparison, it is checked whether or not a difference between the amplitude ratios is within a predetermined range (Step S17). If the difference is not within the predetermined range, the setting value of the liquid crystal element 21 is changed considering the spherical aberration correction information (Step S18) so that retrying of the focus jump is performed (Step S19).

On the contrary, after the comparison, if the difference between the amplitude ratios is within the predetermined range, it is instructed to retry the focus jump without changing the setting of liquid crystal element 21 (Step S19). The operation described above is repeated until the focus jump is completed successfully. However, since the present embodiment adopts the structure in which setting of liquid crystal element 21 for correcting spherical aberration is checked again before retrying the focus jump, the retrying of the focus jump is completed successfully at high probability.

Although each of the two embodiments described above adopts a structure in which the liquid crystal element 21 is used as a spherical aberration correction element for correcting spherical aberration, the present invention should not be limited to this structure. For example, it is possible to use an expander lens that can give spherical aberration to a passing light beam by changing a space between two lens, or the like as the spherical aberration correction element.

Other than that, it is possible to increase a number of light sources that are provided to the optical disc apparatus 1 so that the apparatus can support more types of optical recording media than the embodiment described above. In addition, the optical disc apparatus 1 may not be an apparatus that can record and reproduce information but an apparatus that can only reproduce information unlike the present embodiment.

The optical disc apparatus of the present invention can perform the focus jump for moving the focus position of the light beam emitted from the light source from one recording layer to another recording layer regardless of variation of the optical recording medium, so it is useful as an optical disc apparatus for recording and reproducing information on an optical recording medium having a plurality of recording layers. In addition, since it can support variation of the optical recording medium flexibly, it is possible that the standard of the optical recording medium can have a margin, so it can also contribute to reduction of manufacturing cost of the optical recording medium.

What is claimed is:

1. An optical disc apparatus comprising:
an objective lens for condensing a light beam emitted from a light source onto a recording layer of an optical recording medium;
a light detection unit for receiving reflection light reflected by the recording layer and for converting light information of the reflection light into an electric signal;
a spherical aberration correction element disposed between the light source and the objective lens for performing correction of spherical aberration; and
an actuator for moving the objective lens in the focus direction that is a direction substantially perpendicular to the recording layer, wherein
a focus position of the objective lens is moved by using the actuator from one recording layer to another recording layer of the optical recording medium after the spherical aberration correction element is set to a predetermined setting, and
a preadjustment unit is provided for obtaining setting of the spherical aberration correction element for correcting spherical aberration appropriately in a case where the focus position is adjusted on the recording layer for each of the recording layers of the optical recording medium and for making the obtained setting be the predetermined setting every time when the optical recording medium is loaded to the apparatus.

2. The optical disc apparatus according to claim 1, wherein the preadjustment unit includes
an S shaped curve detection unit that collects signal information of a focus error signal obtained by processing the electric signal while moving the objective lens in the focus direction by the actuator and detects the S shaped curve of the focus error signal based on the collected signal information, and
a spherical aberration correction information obtaining unit that changes setting of the spherical aberration correction element to a plurality of settings having different aberration correction quantities after the S shaped curve is detected, measures amplitude of the S shaped curve in each case of the settings, and obtains setting of the spherical aberration correction element for correcting spherical aberration appropriately in a case where the focus position is adjusted on the recording layer for each of the recording layers of the optical recording medium from the obtained amplitude information of the S shaped curve.

3. The optical disc apparatus according to claim 2, wherein
the spherical aberration correction information obtaining unit calculates an amplitude ratio of a plurality of S shaped curves in each case of the settings if the S shaped curve detection unit detects the plurality of S shaped curves, and obtains also information concerning the amplitude ratio of the S shaped curves and the setting of the spherical aberration correction element as the spherical aberration correction information, and
if movement of the focus position is failed, the predetermined setting of the spherical aberration correction element is readjusted based on the amplitude ratio of the S shaped curve and the spherical aberration correction information when the failure happened.

4. The optical disc apparatus according to claim 2, wherein the preadjustment unit includes a signal gain adjustment block for adjusting a signal gain based on the amplitude value of the S shaped curve obtained by the S shaped curve detection unit.

5. The optical disc apparatus according to claim 3, wherein the preadjustment unit includes a signal gain adjustment block for adjusting a signal gain based on the amplitude value of the S shaped curve obtained by the S shaped curve detection unit.

6. The optical disc apparatus according to claim 2, wherein the S shaped curve detection unit starts time measurement at the same time as starting to collect the focus error signal, and if the collected focus error signal has a maximum value among the signals that have been collected before, time when the maximum value is collected and the maximum value are stored, and
information concerning the maximum value is checked when the objective lens is moved by a predetermined distance in the focus direction and in one of the direction approaching toward the optical recording medium and the direction moving away from the optical recording medium, and if there is not the maximum value stored for longer than a predetermined time period, the information concerning the maximum value is reset, and further the objective lens is moved by a predetermined distance in the direction opposite to said one of the directions.

7. The optical disc apparatus according to claim 3, wherein the S shaped curve detection unit starts time measurement at the same time as starting to collect the focus error signal, and if the collected focus error signal has a maximum value among the signals that have been collected before, time when the maximum value is collected and the maximum value are stored, and
information concerning the maximum value is checked when the objective lens is moved by a predetermined distance in the focus direction and in one of the direction approaching toward the optical recording medium and the direction moving away from the optical recording medium, and if there is not the maximum value stored for longer than a predetermined time period, the information concerning the maximum value is reset, and further the objective lens is moved by a predetermined distance in the direction opposite to said one of the directions.

8. The optical disc apparatus according to claim 4, wherein the S shaped curve detection unit starts time measurement at the same time as starting to collect the focus error signal, and if the collected focus error signal has a maximum value among the signals that have been collected before, time when the maximum value is collected and the maximum value are stored, and
information concerning the maximum value is checked when the objective lens is moved by a predetermined distance in the focus direction and in one of the direction approaching toward the optical recording medium and the direction moving away from the optical recording medium, and if there is not the maximum value stored for longer than a predetermined time period, the information concerning the maximum value is reset, and further the objective lens is moved by a predetermined distance in the direction opposite to said one of the directions.
